(19) United States
(12) Patent Application Publication
(10) Pub. No.: US 2020/0001440 A1
(43) Pub. Date: Jan. 2, 2020

(54) ANVIL AND POWER TOOLS CONTAINING THE SAME

(71) Applicant: TECHTRONIC CORDLESS GP, Anderson, SC (US)

(72) Inventor: Kwan Wing LEE, Kwai Chung (HK)

(21) Appl. No.: 16/454,175

(22) Filed: Jun. 27, 2019

(30) Foreign Application Priority Data
Jun. 29, 2018 (CN) 201810700958.X

(51) Int. Cl. B25B 21/02; B25B 23/00; B25B 21/00

(52) U.S. Cl. CPC B25B 21/02; B25B 21/002; B25B 23/0035

(57) ABSTRACT

This invention discloses an anvil for power tools. The anvil includes an installation mechanism and an engaging mechanism. The installation mechanism is used to install the anvil to the power tool. When the anvil is installed to the power tool, the engaging mechanism is adapted to extend forward from the power tool. The engaging mechanism is adapted to selectively engage one of a plurality of impact sleeves having different internal dimensions. This invention also discloses a power tool having the anvil. The anvil of this invention can selectively engage impact sleeves having different internal dimensions, so that the user does not need to frequently change tools or anvils to carry out different impact operations, the operation flexibility of power tools are effectively improved, and the work efficiency of the user is improved.

### FIELD OF THE DISCLOSURE

This invention relates to an anvil for power tools.

### BACKGROUND

Impact wrench is a common power tool used to tighten and loosen bolts or nuts. FIG. 1A shows an example of an existing impact wrench 10. In this figure, the impact wrench 10 is a cordless electric type (but not connected to the battery pack). The impact wrench 10 contains a housing 12 that defines a handle portion 12H and a battery pack receiving portion 12B. Those arranged in the housing 12 are as follow (not shown): a motor, a control circuit, a gear assembly operatively coupled to the output of the motor, a camshaft coupled to the gear assembly, and an impactor engaged with the camshaft. An anvil 100 (partially shown) is installed on the impactor located in the housing 12.

In operation, as shown in FIG. 1B, the user first places the impact sleeve S on the square part of the anvil 100, and places the impact sleeve S on the bolt to be tightened or loosened (the impact sleeve S is longer than the square part of the anvil 100). The user then presses a trigger switch 14 on the handle portion 12H to activate the motor such that the power is transferred from the motor to the impactor. Thus, the impactor drives the anvil 100 and causes the impact sleeve S to rotate to tighten or loosen the bolt.

CN100449161C shows an anvil of such existing impact wrench and the manner in which it is installed.

The existing impact wrench can only be fitted with one inner size impact sleeve at a time, so only bolts or nuts of one size can be tightened and loosened. The user may need to change tools or anvils when different impact operations are required. This greatly reduces the user's work efficiency.

### SUMMARY

This invention provides a different or improved anvil for power tools.

According to a first aspect of this invention, an anvil for power tools is provided which contains an installation mechanism for installing the anvil on the power tool for connecting with a drive mechanism of the power tool, and an engaging mechanism adapted to extend forward from the power tool when the anvil is installed on the power tool. The engaging mechanism is adapted to selectively engage one of a plurality of impact sleeves having different internal dimensions. Preferably, the engaging mechanism is adapted to engage the following sleeves: ½ inch impact sleeves; ⅜ inch impact sleeves; and ¼ inch impact sleeves. The power tool is preferably an impact wrench.

In a preferred embodiment, the engaging mechanism has a plurality of engaging members. The outer surface of each of the engaging member defines a cross section of a different size for engaging an impact sleeve having corresponding internal dimension. The cross section is one defined by the outer surface of the engaging member, not the cross-sectional area occupied by the material of the engaging member.

In a preferred embodiment, the plurality of engaging members is disposed coaxially.

In a preferred embodiment, the cross section defined by the outer surface of each of the engaging member has a substantially identical shape (but different in their areas). For example, the cross section defined by the outer surface of each of the engaging member has a substantially square shape. In other examples, the cross section may be elliptical, rectangular, pentagonal, hexagonal, etc. The general use is to take into account that in some examples, the section may include chamfers, chamfering, and to take into account manufacturing or machining errors in practice.

In one embodiment, the plurality of engaging members is integrally formed as a single component. Preferably, the plurality of engaging members is arranged away from the front end of the power tool from large to small according to the area of the section. That is, the plurality of engaging members is arranged to extend forward from the power tool in a tapering trend. In one embodiment, the engaging mechanism and the installation mechanism are integrally formed as a single component.

In one embodiment, at least one of the plurality of engaging members is adapted to move axially relative to the another of the plurality of engaging members. Preferably, the plurality of engaging members is axially moveable relative to one another to an approximately flush position of corresponding axial ends of the plurality of engaging members.

In one embodiment, the plurality of engaging members is sleeved together. For example, the plurality of engaging members includes a first engaging member and a second engaging member sleeved on the first engaging member. The second engaging member has a through-hole extending axially. The through-hole extending axially is adapted to receive at least a portion of the first engaging member such that the second engaging member can move axially relative to the first engaging member. Preferably, the second engaging member can move to a position where the axial end of the first engaging member is flush with the axial end of the second engaging member relative to the first engaging member. Preferably, the plurality of engaging members further contains a third engaging member sleeved on the second engaging member. The third engaging member has a through-hole extending axially. The axially extending through-hole of the third engaging member is adapted to receive at least a portion of the second engaging member such as the third engaging member can move axially relative to the first engaging member or the second engaging member. Preferably, the second engaging member and the third engaging member are axially movable relative to the first engaging member to a position roughly flush with corresponding axial ends of the first engaging member, the second engaging member and the third engaging member.

In one embodiment, the anvil further contains a positioning mechanism, which is adapted to position an impact sleeve engaged with the engaging mechanism. Preferably, the positioning mechanism contains a radially moveable locating pin. The locating pin is adapted to move radially outward to position the impact sleeve that engages the engaging mechanism. In a specific embodiment, the plurality of engaging members is sleeved together and is axially moveable relative to each other. The positioning mechanism contains: an elongated grove formed on one of the plurality of engaging members; a locating pin groove formed on an adjacent one of the plurality of engaging members, wherein the engaging member having the locating pin groove is sleeved on the engaging member having the elongated groove; a radially moveable locating pin located in the locating pin groove; the elongated groove extends forward from the power tool, having a first depth close to the power tool and a second depth remote from the power tool, and the first depth is greater than the second dept. When the engaging member having the locating pin groove moves axially away from the power tool relative to the engaging member having the elongated groove, the locating pin moves to the portion of the second depth from the portion of the first depth along the elongated groove to radially move outward to position the impact sleeve engaged with the engaging mechanism. Preferably, the elongated groove is configured that, when the locating pin radially moves outward to position the impact sleeve engaged with the engaging mechanism, the axial end of the engaging member having the locating pin groove is flush with the axial end of the engaging member having the elongated groove.

In one embodiment, the anvil further contains a biasing member, which is adapted to at least on bias in the plurality of engaging members such that corresponding axial ends of the plurality of engaging members are flush in a default configuration. In some embodiments, the anvil may contain a plurality of biasing members, wherein each biasing member biases a corresponding engaging member. For example, the number of the biasing members may be one less than the number of the engaging members. Preferably, the biasing member is arranged between the two of the engaging members. In one embodiment, the biasing member is a compression spring.

In one embodiment, the anvil further contains a locking mechanism. The locking mechanism is adapted to lock the axial position of the engaging member after the engaging member biased by the biasing member is moved axially against the biasing force of the biasing member. As an example, the locking mechanism can contain a pawl, a dog driver, etc. The anvil can also contain an unlocking mechanism, where the unlocking mechanism is adapted to release the locking of the locking mechanism.

In one embodiment, the anvil further contains an actuation component, which is adapted to be actuated by the user to axially move at least one of the plurality of the engaging members. Preferably, the actuation component is adapted to be rotated to axially move at least one of the plurality of engaging members.

In a specific embodiment, the actuation component contains a rotatable annular sleeve. The annular sleeve can define an internal space, which accommodates at least a portion of each of the plurality of engaging members. In one embodiment, at least one of the plurality of engaging members is coupled to a guide pin; the annular sleeve has a guide rail adapted to receive the guide pin; the guide rail extends at least partially axially. Preferably, the guide rail comprising: a first portion extending circumferentially; a second portion extending axially and circumferentially; and a third portion extending circumferentially. In one example, the annular sleeve has a plurality of guide rails adapted to receive corresponding guide pins. Optionally, the number of guide rails is one less than the number of engaging members. The plurality of guide rails can be arranged to enable the engaging members move axially one by one (not simultaneously).

In one embodiment, the engaging mechanism is an expansion mechanism, which is adapted to reversibly extend to engage the inner surface of the impact sleeve. The expansion mechanism may contain a plurality of movable jaws that can be driven to move radially.

In one embodiment, the engaging mechanism contains a jaw chuck. The jaw chuck can be a three-jaw chuck, a four-jaw chuck, etc.

According to the second aspect of this invention, a power tool is provided, and it contains an anvil according to the first aspect of this invention. Preferably, the power tool is an impact wrench, especially a special impact wrench. Optionally, the impact wrench is a cordless electric tool.

The anvil in this invention can selectively engage impact sleeves having different internal dimensions, so that the user does not need to frequently change tools or anvils to carry out different impact operations, and the operating flexibility of power tools is effectively improved, the user's operation is facilitated, and the working efficient of users is improved. The anvil of this invention also reduces the user's need to purchase and store different impact accessories, and reduces related costs (e.g. maintenance costs, storage costs), risks (e.g. the risk of missing accessories) and the time required. In addition, in some embodiments, there is no need to use other tools to switch configurations. The positioning mechanism has a simple structure, and can effectively position the impact sleeve.

Other features and aspects of this invention will become apparent by considering the following detailed descriptions and drawings.

### BRIEF DESCRIPTION OF THE DRAWINGS

Embodiments of this invention will now be described by way of examples with reference to the drawings, wherein:

FIG. 1A is a stereogram of an example of an existing impact wrench;

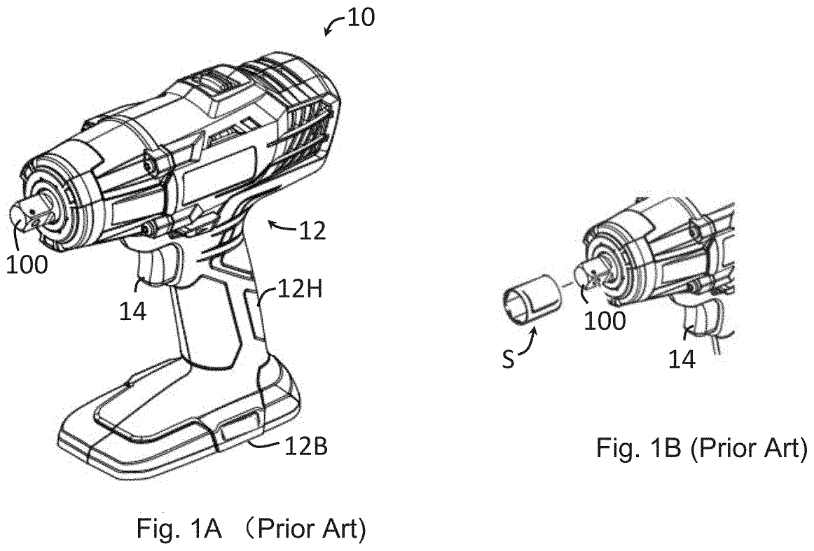

FIG. 1B is a stereogram of the impact wrench in FIG. 1A including the anvil portion and the impact sleeve adapted to it;

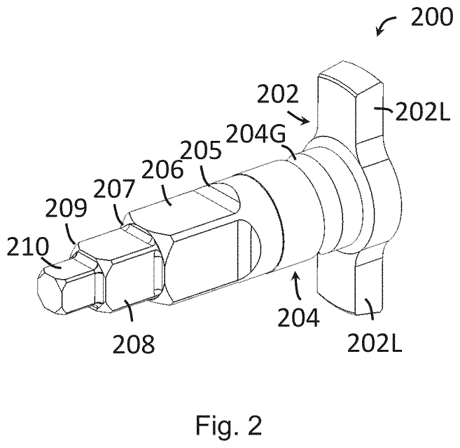

FIG. 2 is a stereogram of an anvil according to an embodiment of this invention;

FIG. 3A is a stereogram of an anvil according to another embodiment of this invention;

FIG. 3B is a cross-sectional stereogram of the anvil in FIG. 3A taken along the line I-I;

FIG. 3C is a cross-sectional view of the anvil of FIG. 3A taken along the line I-I;

FIG. 3D is an exploded view of a portion of the anvil of FIG. 3A;

FIG. 3E is an exploded view of another portion of the anvil of FIG. 3A;

FIGS. 3F to 3H are schematic diagrams of the operation of one of the positioning mechanisms of the anvil in FIG. 3A;

FIG. 31 is a stereogram of the anvil of FIG. 3A in the first configuration;

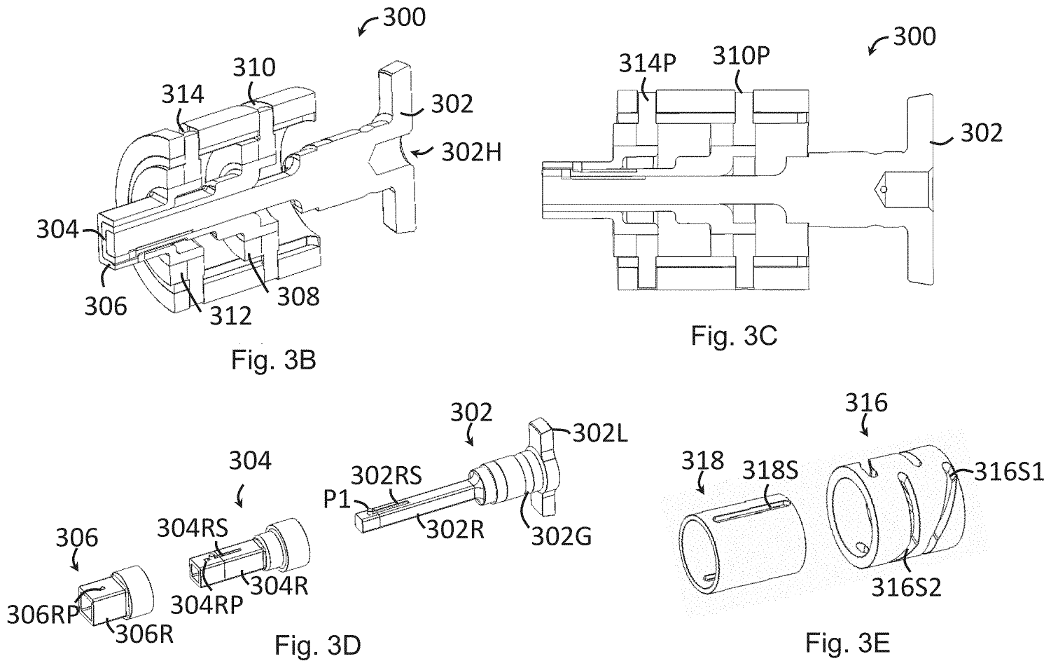

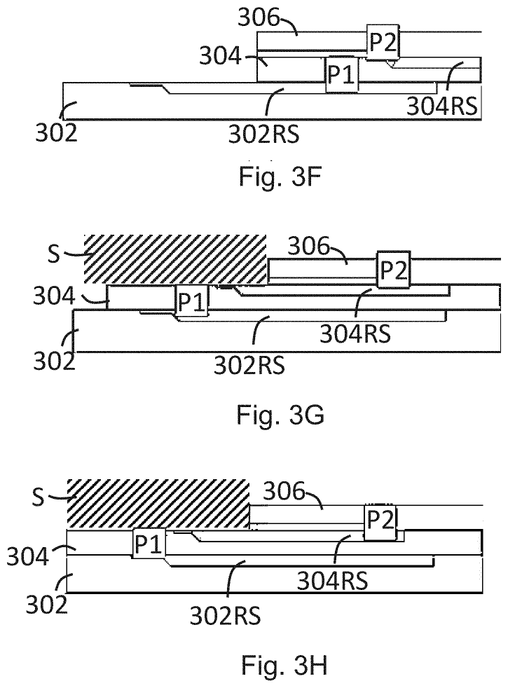

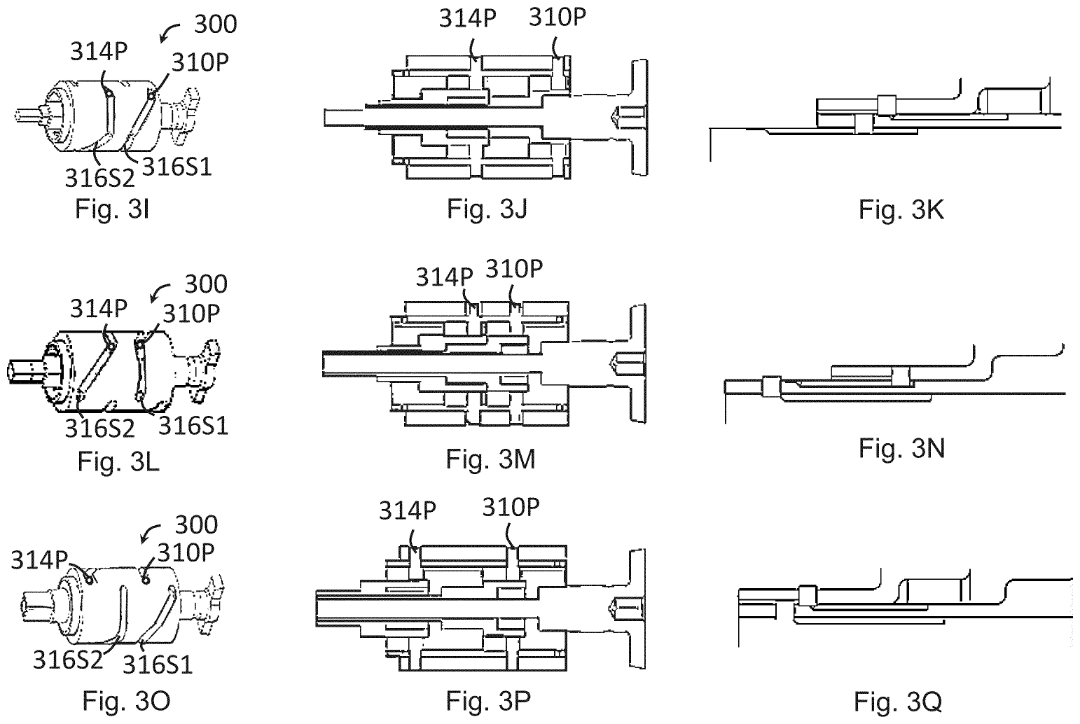

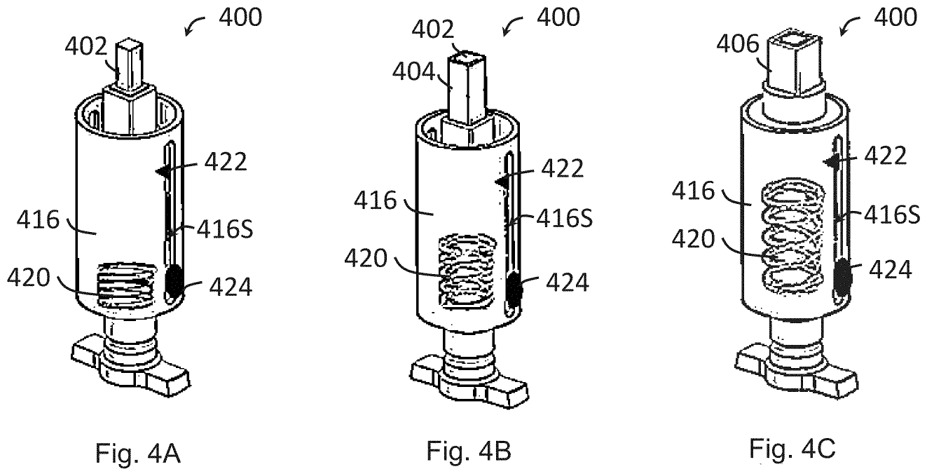

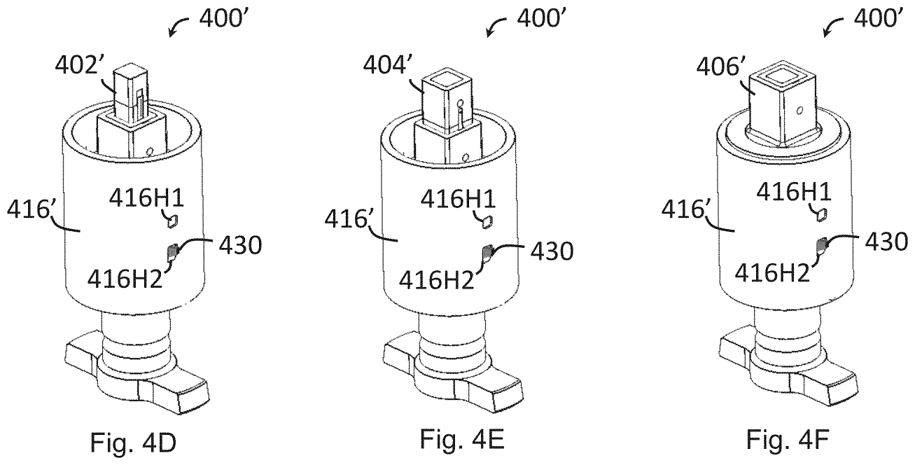

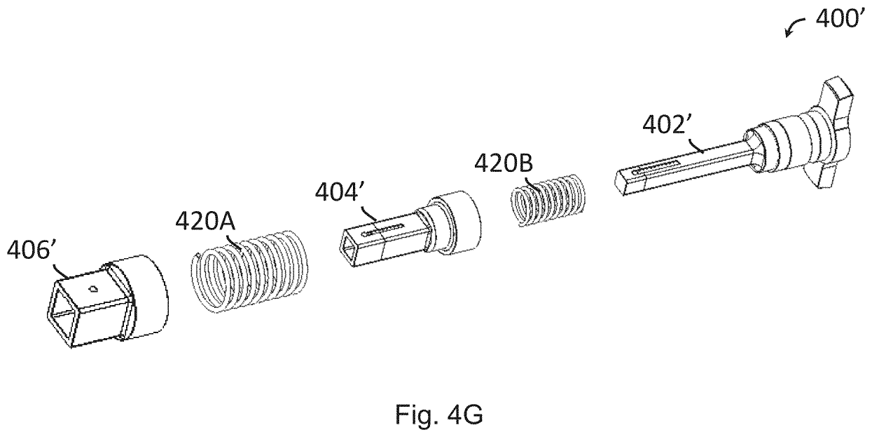

FIG. 3J is a cross section of the anvil of FIG. 3A in the first configuration;

FIG. 3K is a schematic diagram of the positioning mechanism when the anvil in FIG. 3A is in the first configuration;

FIG. 3L is a stereogram of the anvil of FIG. 3A in the second configuration;

FIG. 3M is a cross section of the anvil of FIG. 3A in the second configuration;

FIG. 3N is a schematic diagram of the positioning mechanism when the anvil in FIG. 3A is in the second configuration;

FIG. 3O is a stereogram of the anvil of FIG. 3A in the third configuration;

FIG. 3P is a cross section of the anvil of FIG. 3A in the third configuration;

FIG. 3Q is a schematic diagram of the positioning mechanism when the anvil of FIG. 3A is in the third configuration;

FIG. 4A is a stereogram of the anvil according to another embodiment of this invention in the first configuration;

FIG. 4B is a stereogram of the anvil of FIG. 4A in the second configuration;

FIG. 4C is a stereogram of the anvil of FIG. 4A in the third configuration;

FIG. 4D is a stereogram of the anvil according to another embodiment of this invention in the first configuration;

FIG. 4E is a stereogram of the anvil of FIG. 4D in the second configuration;

FIG. 4F is a stereogram of the anvil of FIG. 4D in the third configuration;

FIG. 4G is an exploded view of a portion of the anvil of FIG. 4D; and

FIG. 5 is a schematic diagram of the anvil according to another embodiment of this invention.

Before explaining any structure of this invention in detail, it should be understood that this invention is not limited to the structural and layout details of the components described below or shown in the attached drawings below. This invention is capable of having other structures and can be practiced or realized in various ways.

### DETAILED DESCRIPTION OF PREFERRED EMBODIMENTS

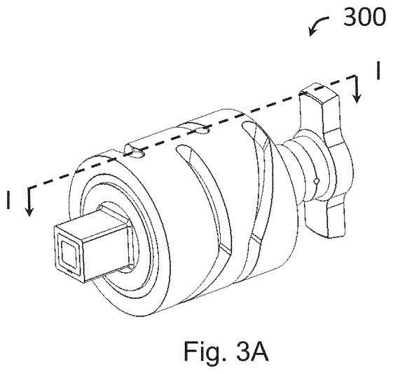

FIG. 2 shows an anvil 200 according to one embodiment of this invention. The anvil 200 generally contains installation mechanisms and engaging mechanisms. The installation mechanism is used for installing the anvil 200 on the power tool to be connected to the driving mechanism (e.g. an impactor). The engaging mechanism is adapted to extend forward from the power tool to engage the impact sleeve when the anvil 200 is installed on the power tool.

Referring to FIG. 2, in this embodiment, the anvil 200 contains an enlarged base 202, a cylindrical portion 204 extending axially from the base 202, a first cuboid portion 206 extending axially from the cylindrical portion 204, a second cuboid portion 208 extending axially from the first cuboid portion 206, and a third cuboid portion 210 extending axially from the second cuboid portion 208. The rounding transition portion is formed between the adjacent parts mentioned above. The base 202 has opposing feet 202L and apertures (now shown) formed in the bottom wall. The base 202 forms an installation mechanism of the anvil 200. The cylindrical portion 204 has an annular groove 204G thereon, which is adapted to receive corresponding fasteners (e.g. steel balls, c-clip, etc.). The installation mechanism is similar to the installation mechanism of the existing anvil and will not be described in details here. The first cuboid portion 206, the second cuboid portion 208 and the third cuboid portion 210 respectively constitute engaging members and form an engaging mechanism of the anvil 200, and the engaging mechanism can selectively engage the impact sleeves having different internal dimensions. The first cuboid portion 206, the second cuboid portion 208 and the third cuboid portion 210 respectively have chamfers extending axially. In this embodiment, the outer surface of the first cuboid portion 206 defines a generally square cross section of the first dimension, the outer surface of the second cuboid portion 208 defines a generally square cross section of the second dimension, and the outer surface of the third cuboid portion 210 defines the generally square cross section of the third dimension, wherein the first dimension is greater than the second dimension, and the second dimension is greater than the third dimension. So, the three cuboid portions can respectively engage three impact sleeves with different internal dimensions. As an example, the first cuboid portion 206 can be used to engage ½ inch impact sleeves. The first cuboid portion 206 can be used to engage ⅜ inch impact sleeves. The third cuboid portion 210 can be used to engage ¼ inch impact sleeves. As shown in FIG. 2, the three cuboid portions 206, 208 and 210 are coaxially disposed. In this embodiment, the anvil 200 is formed as a single component. When the anvil 200 is installed in the impact wrench 20, the three cuboid portions 206, 208 and 210 extend from the front end of the impact wrench 20 to engage the impact sleeve.

In the operation, if the user installs the impact sleeve of which the internal dimension fits the third cuboid portion 210 on the third cuboid portion 210, a transition portion 209 between the second cuboid portion 208 and the third cuboid portion 210 will push against the end face of the impact sleeve. If the user installs the impact sleeve of which the internal dimension fits the second cuboid portion 208 on the second cuboid portion 208, a transition portion 207 between the first cuboid portion 206 and the second cuboid portion 208 will push against the end face of the impact sleeve. If the user installs the impact sleeve of which the internal dimension fits the first cuboid portion 206 on the first cuboid portion 206, a transition portion 205 between the cylindrical portion and the first cuboid portion 206 will push against the end face of the impact sleeve.

It should be understood that, in other embodiments, many variations and/or modifications can be made to the embodiment of FIG. 2. For example, the structure of the anvil can be different. The engaging mechanism can selectively engage other impact sleeves of different sizes. The engaging members of the engaging mechanism may have the same or different shapes, such as ellipses, rectangles, pentagons, hexagons, etc. The number of the engaging members may be two or more than three, and they do not have to be coaxially disposed. All of the engaging members are preferably formed integrally as a single component, but this is not required. The engaging mechanism and the installation mechanism can be integrally formed as a single component, but this is not required. There may be other transition portions between adjacent engaging members. Optionally, the locating pin hole can be formed on one of the surfaces of the engaging member to receive the locating pin for positioning the engaged impact sleeve.

FIG. 3A shows an anvil 300 according to one embodiment of this invention. The anvil 300 generally comprises an installation mechanism and an engaging mechanism. The installation mechanism is used to install the anvil 300 on the power tool to be connected with the driving mechanism (e.g. an impactor) of the power tool. The installation mechanism is similar to the installation mechanism of the existing anvil, and it will not be described in detail here. The engaging mechanism is adapted to extend forward from the power tool to engage the impact sleeve when the anvil 300 is installed on the power tool.

Referring to FIGS. 3A to 3E, the anvil 300 contains a first engaging member 302, a second engaging member 304, a third engaging member 306, a bearing 308 and a guide ring 310 coupled to the second engaging member 304, a bearing 312 and a guide ring 314 coupled to the third engaging member 306, an outer annular sleeve 316 and an inner annular sleeve 318. The first engaging member 302 is longer than the second engaging member 304, and the third engaging member 306 is longer than the second engaging member 304. The outer annular sleeve 316 and the inner annular sleeve 318 define the inner space. The first engaging member 302, the second engaging member 304 and the third engaging member 306 are all at least partially located in the inner space. The first engaging member 302, the second engaging member 304 and the third engaging member 306 are coaxially disposed and sleeved together.

The first engaging member 302 contains an enlarged base, a cylindrical portion extending axially from the base, and a first cuboid portion 302R extending axially from the cylindrical portion. The cross-sectional area defined by the outer surface of the cylindrical portion is larger than the cross-sectional area defined by the outer surface of the first cuboid portion 302R. A rounding transition portion is formed between adjacent portions. The base has opposing feet 302L and apertures 302H formed in the bottom wall. The base forms at least a portion of the installation mechanism of the anvil 300. The cylindrical portion has an annular groove 302G thereon, which is adapted to receive corresponding fasteners (e.g. steel balls, c-clips, etc.). An elongated groove 302RS extending axially is formed on the first cuboid portion 302R, and it is adapted to receive a locating pin P2 such that the locating pin is movable between the axial ends of the elongated groove 302RS.

The second engaging member 304 contains a first cylindrical portion, a second cylindrical portion extending axially from the first cylindrical portion, and a second cuboid portion 304R (hollow) extending axially from the second cylindrical portion. The cross-sectional area defined by the outer surface of the first cylindrical portion is larger than the cross-sectional area defined by the outer surface of the second cylindrical portion. The cross-sectional area defined by the outer surface of the second cylindrical portion is larger than the cross-sectional area defined by the outer surface of the second cuboid portion 304R. The rounding transition is formed between adjacent portions. An elongated groove 304RS extending axially is formed on the second cuboid portion 304R, and it is adapted to receive the locating pin to enable the locating P2 to move between the axial ends of the elongated groove 304RS. A locating pin groove 304RP is also formed on the second cuboid portion 304R, and it is located at the axial front end of the elongated groove 304RS. The locating pin groove 304RP is adapted to receive the locating pin P1, and the locating P1 can move radially in the locating pin groove 304RP. In this example, the locating pin is cylindrical. The second engaging member 304 defines the through-hole extending axially so that it can be sleeved on the first engaging member 302 and thus can move radially relative to the first engaging member 302. The bearing 308 and the guide ring 310 are coupled to the first cylindrical portion of the second engaging member 304 respectively. The guide ring 310 has opposing guide pins 310P extending radially.

The third engaging member 306 contains a cylindrical portion and a third cuboid portion 306R (hollow) extending axially from the cylindrical portion. The cross-sectional area defined by the outer surface of the cylindrical portion is larger than the cross-sectional area defined by the outer surface of the third cuboid portion 306R. The rounding transition portion is formed between adjacent portions. A locating pin groove 306RP is formed on the third cuboid portion 306R, and it is adapted to receive the locating pin P2, and the locating pin P2 can move radially in the locating pin groove 306RP. In this example, the locating pin is cylindrical. The third engaging member 306 defines the through-hole extending radially so that it can be sleeved on the second engaging member 304 and thus can move radially relative to the first engaging member 302 or the second engaging member 304. The bearing 312 and the guide ring 314 are coupled to the cylindrical portion of the third engaging member 306 respectively. The guide ring 314 has opposing guide pins 314P extending radially.

The first cuboid portion 302R, the second cuboid portion 304R and the third cuboid portion 306R respectively constitute engaging members and form an engaging mechanism of the anvil 300, and the engaging mechanism can selectively engage impact sleeves having different internal dimensions. The first cuboid portion 302R, the second cuboid portion 304R and the third cuboid portion 306R respectively have a chamfer extending radially. In this embodiment, the outer surface of the first cuboid portion 302R defines the generally square cross section of the first size, the outer surface of the second cuboid portion 304R defines the generally square cross section of the second size, the outer surface of the third cuboid portion 306R defines the generally square cross section of the third size, wherein the first size is greater than the second size, and the second size is greater than the third size. Thus, the three cuboid portions can respectively engage three impact sleeves with different internal dimensions. As an example, the first cuboid portion 302R can be used to engage ½ inch impact sleeves. The first cuboid portion 302R can be used to engage ⅜ inch impact sleeves. The third cuboid portion 306R can be used to engage ¼ inch impact sleeves.

The outer annular sleeve 316 and the inner annular sleeve 318 have substantially the same length. The inner annular sleeve 318 has opposing elongated grooves 318S extending radially. The outer annular sleeve 316 has two guide rails 316S1 and 316S2. The elongated groove 318S and the guide rails 316S1 and 316S2 are used to receive the guide pins 310P and 314P of the guide ring. The first guide rail 316S1 contains a first portion that extends only circumferentially, a second portion that extends axially and circumferentially and a third portion that extends only circumferentially. The second guide rail 316S2 also contains a first portion that extends circumferentially, a second portion that extends axially and circumferentially and a third portion that extends only circumferentially. The first portion of the second guide rail 316S2 is longer than the first portion of the first guide rail 316S1. The third portion of the second guide rail 316S2 is shorter than the third portion of the first guide rail 316S1. The outer annular sleeve 316 forms an actuation component of the anvil 300. The user can move the second engaging member 304 and the third engaging member 306 by actuating or rotating the outer annular sleeve 316. In this embodiment, the guide rail 316S1 and 316S2 are configured such that the three engaging members 302, 304 and 306 are axially moveable relative to each other to a position that is substantially flush with their corresponding axial ends. Specifically, the first guide rail 316S1 is configured such that the second engaging member 304 is moveable relative to the first engaging member 302 to a position that is substantially flush with its corresponding axial end. The second guide rail 316S2 is configured such that the third engaging member 306 is moveable relative to the first engaging member 302 and the second engaging member 304 to a position that is substantially flush with its corresponding axial end.

FIGS. 3F to 3H show the operation of one of the positioning mechanisms of the anvil 300. In this example, the positioning mechanism contain an elongated groove 302R formed on the first engaging member 302, a locating pin groove formed on the second engaging member 304 and a radially moveable locating pin P1 located in the locating pin groove. Similar positioning mechanisms are formed by the elongated groove on the second engaging member 304, the locating pin groove of the third engaging member 306 and the radially moveable locating pin P2 located in the locating pin groove.

As shown in FIGS. 3F to 3H, the bottom wall of the elongated groove 302RS defines a deeper first depth (near the base or power tool of the first engaging member 302) and a shallower second depth (away from the base or power tool of the first engaging member 302). There is an inclined plane transition portion between the first depth and the second depth. At the initial position, the second engaging member 304 is set on the first engaging member 302 and does not extend. At this time, the locating pin P1 is located at the first depth portion of the elongated groove 302RS. As the user puts the impact sleeve fitted to the second engaging member 304 on the anvil 300 and rotate the outer annular sleeve 316 to extend the second engaging member 304, the locating pin moves to the inclined plane transition portion along the first depth portion of the elongated groove 302RS. At this time, the locating pin P1 is gradually pushed to move radially outward due to the decrease in depth. Thereafter, the locating pin P1 moves to the second depth portion of the elongated groove to abut the end wall of the elongated groove 302RS. At this time, the axial ends of the first engaging member 302 and the second engaging member 304 are substantially flush. At the same time, the locating pin P1 moves radially outward to engage the impact sleeve (with corresponding engaging features) to position the impact sleeve. The user can inversely rotate the outer annular sleeve 316 to release the positioning mechanism.

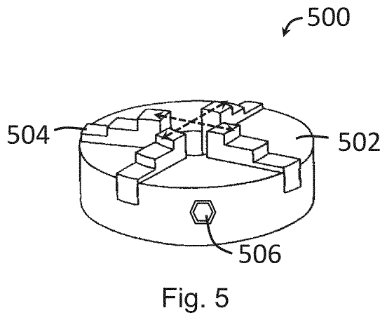

FIGS. 31 to 3K show that the anvil is in the first configuration (neither the second engaging member 304 nor the third engaging member 306 extends). In this configuration, the guide pin 310P of the guide ring of the second engaging member 304 is located in the first portion that is in the first guide rail 316S1 and extends only circumferentially, and the guide pin 314P of the guide ring of the third engaging member 306 is located in the first portion that is in the second guide rail 316S2 and extends only circumferentially.

FIGS. 3L to 3N show that the anvil is in the second configuration (the second engaging member 304 extends to a position that is substantially flush with the axial end of the first engaging member 302, and the third engaging member 306 does not extend). The user moves the anvil from the first configuration to the second configuration by rotating the outer annular sleeve 316. In this configuration, the guide pin 310P of the guide ring of the second engaging member 304 is located in the third portion that is in the first guide rail 316S1 and extends only circumferentially, and the guide pin 314P of the guide ring of the third engaging member 306 is located in the first portion (near the second portion) that is in the second guide rail 316S2 and extends only circumferentially. It can be seen that the locating pin of the second engaging member 304 moves radially outward to a position that engages the impact sleeve (with corresponding engaging features).

FIGS. 30 to 3Q show that the anvil is in the third configuration (the second engaging member 304 and the third engaging member 306 both extend to a position that is substantially flush with the axial end of the first engaging member 302). The user moves the anvil from the second configuration to the third configuration by rotating the outer annular sleeve 316. In this configuration, the guide pin 310P of the guide ring of the second engaging member 304 is located at the end of the third portion that is in the first guide rail 316S and extends only circumferentially, and the guide pin 314P of the guide ring of the third engaging member 306 is located at the end of the third portion that is in the second guide rail 316S2 and extends only circumferentially. It can be seen that the locating pin of the third engaging member 306 moves radially outward to a position that engages the impact sleeve (with corresponding engaging features).

It should be understood that, in other embodiments, many variations and/or modifications may be made to the embodiment of FIG. 3A. For example, the structures of the anvil can be different. The engaging mechanism can selectively engage other impact sleeves having different sizes. The engaging members of the engaging mechanism may have the same or different shapes, such as ellipses, rectangles, pentagons, hexagons, etc. The number of the engaging members may be two or more than three, and they do not have to be coaxially disposed. There may be other transition portions between the portions of the engaging members. The positioning mechanism is not required. The outer annular sleeve and the inner annular sleeve can be in different forms. The second portions of the first guide rail and the second guide rail can have varying degrees of axial and radial extension ranges.

FIGS. 4A to 4C show a schematic diagram of an anvil 400 according to one embodiment in this invention. The anvil 400 similar to the embodiment of FIG. 3A. The difference is that the anvil 400 does not have an actuation component in the form of an outer annular sleeve. Instead, the second engaging member 404 and the third engaging member 406 of the anvil 400 are respectively biased by the biasing member 420 to a position that is substantially flush with the axial end of the first engaging member 402. Thus, in the default configuration, the corresponding axial ends of all engaging members 402, 402 and 406 will be substantially flush. In this embodiment, the biasing member 420 is a compression spring. The anvil 400 further contains a locking mechanism 422 adapted to lock the engaging member against the biasing force of the biasing member, and an unlocking mechanism 424 for releasing the locking of the locking mechanism. In this embodiment, the anvil 400 has an annular sleeve 416 with an elongated groove 416S extending axially formed thereon. The locking mechanism and the unlocking mechanism can be partially disposed in the elongated groove 416S.

FIGS. 4D to 4F serve as an anvil 400′ of one example of the anvil 400. The anvil 400′ contains an annular sleeve 416′, on which axially aligned holes 416H1 and 416H2 are formed. A radially outwardly biased spring arm (the elasticity is provided by the structure of the material itself) (located in the annular sleeve 416′) is connected to the second engaging member 404′. The end of the spring arm has a protruding part 430 adapted to extend into the hole. The protruding part has a downward inclined surface adapted to retract from the upper hole 416H1 to the lower hole 416H2 when the second engaging member 404′ is pressed by the user. In this embodiment, the spring arm provides a click sound when entering the lower hole 416H2 to let the user know that the second engaging member 404′ has been locked. To unlock the second engaging member 404′, the user simply presses the protruding part 430 to retract it from the lower hole 416H2. Due to the biasing of the biasing member, the protruding part 430 will automatically return to the upper hoe 416H1. The third engaging member 406′ can have a corresponding arm arrangement (the annular sleeve contains another pair of axially aligned holes (not shown)). FIG. 4G is an example of the configuration of a biasing member. As shown in FIG. 4G, a compression spring 420B is disposed between the first engaging member 402′ and the second engaging member 404′, and another compression spring 420A is disposed between the first engaging member 404′ and the third engaging member 406′.

In operation, the user can insert the impact sleeve fitted to the first engaging member 402′ directly on the anvil. The impact sleeve will press the second engaging member 404′ and the third engaging member 406′ away from the first engaging member 402′. The second engaging member 404′ and the third engaging member 406′ can be respectively locked by the locking mechanism. The positioning mechanism of the first engaging member 402′ can engage the impact sleeve. The user can also insert the impact sleeve fitted to the second engaging member 404′ directly on the anvil. The impact sleeve will press the third engaging member 406′ away from the first engaging member 402′. The third engaging member 406′ is locked by the locking mechanism. The positioning mechanism of the second engaging member 404′ can engage the impact sleeve. The user can also insert the impact sleeve fitted to the third engaging member 406′ directly on the anvil. The impact sleeve will be put directly on the third engaging member 406′.

It should be understood that, in other embodiments, many variations and/or modifications may be made to the embodiments of FIGS. 4A and 4G. For example, the structures of the anvil can be different. The engaging mechanism can selectively engage other impact sleeves having different dimensions. The engaging members of the engaging mechanism may have the same or different shapes, such as ellipses, rectangles, pentagons, hexagons, etc. The number of the engaging members may be two or more than three, and they do not have to be coaxially disposed. There may be other transition portions between portions of the engaging member. The positioning mechanism is not required. The biasing member can be in other forms. The locking mechanism and the unlocking mechanism can be in other forms. For example, another sleeve can be arranged in the annular sleeve, and this sleeve has corresponding locking and unlocking grooves.

FIG. 5 shows an anvil 500 according to one embodiment of this invention. The anvil 500 generally contains an installation mechanism and an engaging mechanism. The installation mechanism (not shown) is used to install the anvil 500 to the power tool to be connected with the driving mechanism of the power tool (e.g. an impactor). The engaging mechanism is adapted to extend forward from the power tool to engage the impact sleeve when the anvil 500 is installed on the power tool. Referring to FIG. 5, in this embodiment, the engaging mechanism contains a body 502 and four movable jaws 504 installed on the body 502. The movable jaws 504 can be driven to move radially respectively. The movable jaws 504 generally have the same form and are spaced apart at even angles. The installation mechanism is formed by a portion of the body 502, and the engaging mechanism is mainly formed by the movable jaw 504.

In operation, the user puts the impact sleeve on the movable jaw 504. Then, the user inserts the key or bolt into an adjustment hole 506 and rotates the key or bolt to move the movable jaw 504 of the anvil 500 radially outward so as to grasp the impact sleeve. In this embodiment, the anvil 500 can engage any impact sleeve having an internal dimension that is greater than the outer dimension defined by the movable jaw.

It should be understood that, in other embodiments, many variations and/or modifications can be made to the embodiment of FIG. 5. For example, the structures of the anvil can be different. The engaging mechanism can be a chuck, a jaw chuck, or other expansion mechanism that can expand to engage the inner surface of the impact sleeve. The engaging mechanism may contain two or more movable jaws, and may also contain at least one fixed jaw and at least one movable jaw. The movable jaws can be individually controlled to move independently, or the movable jaws can be controlled to move together. A locating pin hole and a locating pin may be provided on the movable jaw for positioning the impact sleeve. Alternatively, other positioning features (e.g. frication surfaces, protruding parts, etc.) may be provided on the movable jaw.

Several embodiments of the anvil of this invention are described above. It should be understood that the power tool corresponding to the anvil in this invention may have different structures, or have increased or decreased functional or structural features. Functional or structural features of different embodiments may be arbitrarily combined to provide other embodiments. In addition, the anvil of this invention may also have different structures, or have increased or decreased functional or structural features. A person skilled in the art will recognize that many variations and/or modifications (e.g. as described above) can be made to this invention shown in the specific embodiments without deviating from the spirit or scope of this invention. The current embodiments are therefore considered in all aspects as exemplary but not restrictive.

The anvil of this invention can be used for any power tools. The power tool can use compressed air or hydraulic pressure as a power source, and can also use electric power as a power source. The power tool can be an electric tool using DC power (e.g. using a battery pack), AC power (e.g. using a power cord to connect to an AC power source), or a DC/ac hybrid power supply. The power tool is preferably cordless. The power tool is preferably a rotary power tool or a power tool having a rotary mode, which is adapted to receive and drive an anvil to perform impact work. Preferably, the power tool is an impact wrench, especially a special impact wrench. The anvil can be detachable from the power tool or non-detachable from the power tool.

1. An anvil for power tools, comprising:
an installation mechanism for installing the anvil to the power tool to connect with the drive mechanism of the power tool; and
an engaging mechanism adapted to extend forward from the power tool when the anvil is installed on the power tool;
wherein the engaging mechanism is adapted to selectively engage one of a plurality of impact sleeves having different internal dimensions.

2. The anvil according to claim 1, wherein the engaging mechanism is adapted to selectively engage the following impact sleeves: ½ inch impact sleeves; ⅜ inch impact sleeves; and ¼ inch impact sleeves.

3. The anvil according to claim 1, wherein the engaging mechanism has a plurality of engaging members, and wherein the outer surface of each of the engaging members defines cross sections of different dimensions for engaging impact sleeves having corresponding internal dimensions.

4. The anvil according to claim 1, wherein the plurality of engaging members is coaxially arranged.

5. The anvil according to claim 1, wherein the cross section defined by the outer surface of each of the engaging members has approximately the same shape.

6. The anvil according to claim 5, wherein the cross section defined by the outer surface of each of the engaging members is a roughly square cross section.

7. The anvil according to claim 1, wherein the plurality of engaging members is integrally formed as a single component.

8. The anvil according to claim 1, wherein the plurality of engaging members is arranged to be away from the front end of the power tool from large to small according to the area of the section.

9. The anvil according to claim 1, wherein the engaging mechanism and the installation mechanism are integrally formed as a single component.

10. The anvil according to claim 1, wherein the plurality of engaging members is sleeved together.

11. The anvil according to claim 10, wherein at least one of the plurality of engaging members can move in an axial direction relative to another of the plurality of engaging members.

12. The anvil according to claim 11, wherein the plurality of engaging members can move axially relative to one another to approximately flush positions at the corresponding axial ends of the plurality of engaging members.

13. The anvil according to claim 12, wherein the plurality of engaging members includes a first engaging member and a second engaging member sleeved on the first engaging member, wherein the second engaging member has a through-hole extending axially, and wherein the through-hole extending axially is adapted to receive at least a portion of the first engaging member so that the second engaging member can move axially relative to the first engaging member.

14. The anvil according to claim 13, wherein the second engaging member can move to a position where the axial end of the first engaging member is flush with the axial end of the second engaging member relative to the first engaging member.

15. The anvil according to claim 14, wherein the plurality of engaging members further includes a third engaging member sleeved on the second engaging member;
the third engaging member has a through-hole extending axially;
the axially extended through-hole of the third engaging member is adapted to receive at least a portion of the second engaging member so that the third engaging member can move axially relative to the first engaging member or the second engaging member.

16. The anvil according to claim 15, wherein the second engaging member and the third engaging member can move to axially move to the position roughly flush with the axial ends of the first engaging member, the second engaging member and the third engaging member.

17. The anvil according to claim 1, further comprising a positioning mechanism which ii adapted to position an impact sleeve engaged with the engaging mechanism.

18. The anvil according to claim 17, wherein the positioning mechanism comprises a locating pin which can move radially and wherein the locating pin is adapted to move radially outward to position the impact sleeve engaged with the engaging mechanism.

19. The anvil according to claim 17, wherein the plurality of engaging members is sleeved together and can move axially relative to each other; the positioning mechanism comprising:
an elongated groove on one of the plurality of the engaging members;
a locating pin groove on an adjacent one of the plurality of the engaging members;
wherein the engaging member having a locating pin groove is sleeved on the engaging member having an elongated groove;
a radially moveable locating pin located in the locating pin groove;
wherein the elongated groove extends forward from the power tool, having a first depth near the power tool and a second depth away from the power tool, and the first depth is greater than the second depth;
wherein when the engaging member having the locating pin moves axially relative to the engaging member having the elongated groove to be away from the power tool, the locating pin moves to the part of the first depth to the part of the second depth along the elongated groove, to radially move outward for positioning the impact sleeve engaged with the engaging mechanism.

20. The anvil according to claim 19, wherein the elongated groove is arranged so that when the locating pin radially moves outward to position the impact sleeve engaged with the engaging mechanism, the axial end of the engaging member having the locating pin groove is roughly flush with the axial end of the engaging member having the elongated groove.

21. The anvil according to claim 11, further comprising a biasing member adapted to bias at least one of the plurality of engaging members so that the corresponding axial ends of the plurality of engaging members in a default configuration are flush.

22. The anvil according to claim 21, wherein the biasing member is arranged between the two engaging members.

23. The anvil according to claim 21, wherein the biasing member is a compression spring.

24. The anvil according to claim 21, further comprising a locking mechanism adapted to lock the axial position of the engaging member after the engaging member biased by the biasing member is moved axially against the biasing force of the biasing member.

25. The anvil according to claim 24, further comprising an unlocking mechanism adapted to release the lock of the locking mechanism.

26. The anvil according to claim 10, further comprising an actuation component adapted to be actuated by a user to axially move at least one of the plurality of engaging members.

27. The anvil according to claim 26, wherein the actuation component is adapted to be rotated to axially move at least one of the plurality of engaging members.

28. The anvil according to claim 27, wherein the actuation component comprises a rotatable annular sleeve.

29. The anvil according to claim 28, wherein the annular sleeve defines an internal space, which accommodates at least a portion of each of the plurality of engaging members.

30. The anvil according to claim 29, wherein at least one of the plurality of engaging members is coupled to a guide pin, wherein the annular sleeve has a guide rail adapted to receive the guide pin, and wherein the guide rail extends at least partially along the axis.

31. The anvil according to claim 30, wherein the guide rail comprises
a first portion that extends circumferentially;
a second portion that extends axially and circumferentially; and
a third portion that extends circumferentially.

32. The anvil according to claim 31, wherein the annular sleeve comprises at least two guide rails, each of which is adapted to receive the guide pin of the corresponding engaging member.

33. The anvil according to claim 1, wherein the engaging mechanism comprises an extension mechanism adapted to reversibly extend to engage the inner surface of the impact sleeve.

34. The anvil according to claim 33, wherein the expansion mechanism comprises a plurality of movable jaws that can be driven to move radially.

35. The anvil according to claim 1, wherein the engaging mechanism comprises a jaw chuck.

36. A power tool comprising:
an anvil including
an installation mechanism for installing the anvil to the power tool to connect with the drive mechanism of the power tool; and
an engaging mechanism adapted to extend forward from the power tool when the anvil is installed on the power tool;
wherein the engaging mechanism is adapted to selectively engage one of a plurality of impact sleeves having different internal dimensions.

37. The power tool according to claim 36, wherein the power tool is an impact wrench.
